(19) United States
(12) Patent Application Publication
(10) Pub. No.: US 2013/0075534 A1
(43) Pub. Date: Mar. 28, 2013

(54) METHOD FOR REMOVING ORBITAL OBJECTS FROM ORBIT USING A CAPTURE NET FOR MOMENTUM TRANSFER

(71) Applicant: Composite Technology Development, Inc., Lafayette, CO (US)

(72) Inventors: Robert Taylor, Superior, CO (US); Ian Gravseth, Longmont, CO (US); Dana Turse, Broomfield, CO (US); Philip Keller, Longmont, CO (US); Mike Hulse, Erie, CO (US); Doug Richardson, Westminster, CO (US)

(73) Assignee: Composite Technology Development, Inc., Lafayette, CO (US)

(21) Appl. No.: 13/621,448

(22) Filed: Sep. 17, 2012

Related U.S. Application Data
(60) Provisional application No. 61/535,814, filed on Sep. 16, 2011.

(51) Int. Cl. B64G 4/00; B64G 1/64; B64G 1/24

(52) U.S. Cl. CPC B64G 4/00; B64G 1/242; B64G 1/64
USPC 244/158.2; 244/158.6; 701/3; 244/173.3

(57) ABSTRACT

In some embodiments of the invention, methods and devices are provided that perturb a trajectory of a space-orbital object. For example, a spacecraft may be sent to a location near a space-orbital object orbiting the Earth. A net may be released from the spacecraft in a manner (e.g., with a given alignment, direction and velocity) that results in the net contacting and/or entangling with the object. This contact or entanglement may alter a velocity of the space-orbital object and thereby may alter its orbital path. In some instances, the net's velocity is sufficient to experience increase drag by the Earth's atmosphere, relative to the drag it would have otherwise experienced if the net did not contact the object.

### CROSS-REFERENCES TO RELATED APPLICATIONS

This is a non-provisional application that claims the benefit of commonly assigned U.S. Provisional Application No. 61/524,612, filed Sep. 16, 2011, entitled “A Method for Removing Debris Objects from Orbit Using a Capture Net for Momentum Transfer,” the entirety of which is herein incorporated by reference for all purposes.

### BACKGROUND OF THE INVENTION

Launching an object (e.g., a satellite or launch vehicle) into orbit may result in space debris. For example, the operator may lose control of the entire object, or the object may separate into multiple parts (e.g., following a collision or explosion)—at least one of which is uncontrolled.

Space debris may remain in orbit a seemingly indefinite period of time due to the operator's inability to retrieve it. Existing space debris may collide with a device, such as a satellite or robotic spacecraft. The collision may damage the device, alter its orbit and/or remove the device from an operator's control. A collision with a orbital object of only a couple kilograms has the potential to completely destroy a spacecraft. If the operator gains knowledge of the debris's location, the operator may alter an orbital path of the device in an attempt to avoid a collision. However, this modification will restrict the orbital paths available to the device.

Many space-orbital objects already exist in orbit. Additionally, collisions between the orbital objects increase the number of orbital objects that must be avoided by satellites or spacecraft. Thus, it would be desirable to remove space debris from orbit.

### BRIEF SUMMARY OF THE INVENTION

In some embodiments of the invention, a method for disturbing a trajectory of a space-orbital object is provided. The method may include: positioning a spacecraft near the space-orbital object, the space-orbital object comprising an uncontrolled object orbiting Earth; and propelling a capture net from the spacecraft towards the space-orbital object. The capture net may be propelled from the spacecraft with a velocity sufficient to cause the space-orbital object to contact the net. The velocity may also be sufficient to, upon contact with the net: substantially alter (e.g., decrease) an orbital velocity of the space-orbital object and/or disrupt an orbit of the space-orbital object. The capture net's velocity may be sufficient to cause the space-orbital object to, half an orbit after contact with the net, experience increased drag by the Earth's atmosphere as compared to the drag that would have been experienced half an orbit later had the object not been contacted by net. The capture net may be coupled to one or more rockets. The spacecraft may be positioned along an orbit of the space-orbital object. The method may further include locating the space-orbital object. The capture net may include a rigid perimeter and a recessed interior for receiving the space-orbital object. A maximal depth of the capture net may be between about 1 meter and about 50 meters. The capture net may be propelled using one or more of a chemical explosion, compressed gas, and a mechanical spring. The capture net may be shaped to at least partly contain the space-orbital object upon contact.

In some embodiments of the invention, a method for identifying properties for ejecting a capture net from a spacecraft is provided. The method may include: identifying a location of the spacecraft; predicting a future location of a space-orbital object based on an estimated location and trajectory of the space-orbital object; estimating a mass of the space-orbital object; determining an ejection direction for ejection of the capture net based on the location of the spacecraft and the projected future location of the space-orbital object; and determining an ejection velocity for ejection of the capture net based on a mass of the capture net, the estimated mass of the space-orbital object, and a radial distance between an orbit of the space-orbital object and the top of the Earth's atmosphere. The method may further include ejecting the capture net from the spacecraft at the determined ejection velocity. The ejection velocity may be determined further based on an orbital trajectory of the space-orbital object. The determined ejection velocity may be sufficient to cause the net to contact the space-orbital object. The determined ejection velocity may be sufficient to cause the space-orbital object to, half an orbit after contact with the net, experience increased drag by the Earth's atmosphere as compared to the drag that would have been experienced half an orbit later had the object not been contacted by net. Determining the ejection velocity may include: determining a desired velocity of the space-orbital object; and determining the ejection velocity based on a conservation-of-momentum principle.

In some embodiments of the invention, a capture net for capturing a space-orbital object is provided. The net may include one or more rigid components; a surface attached to the rigid component; and a rocket, wherein the capture net is formed in an open shape for receiving the space-orbital object upon propulsion of the one or more rigid components. The rigid components may include a ring and/or one or more spherical anchors. A maximum diameter of the capture net may be between about 0.5 meters and 20 meters. The surface may be flexible. The rocket may be configured to be activated by a remote control. The capture net may be of a rigid conical shape. The net may further include a tether coupling the he rocket to at least one of the one or more rigid components.

### BRIEF DESCRIPTION OF THE DRAWINGS

FIG. 1 shows an exemplary method 100 for altering a path of a space-orbital object.

FIGS. 2A and 2B show an exemplary capture net.

FIG. 3 shows an exemplary capture net and a spacecraft.

FIG. 4 shows an exemplary capture net.

FIG. 5 shows an illustration of a spacecraft that expelled a capture net to alter a path of a space-orbital object.

### DETAILED DESCRIPTION OF THE INVENTION

In some embodiments of the invention, methods and devices are provided that perturb a trajectory of a space-orbital object. For example, a spacecraft may be sent to a location near a space-orbital object orbiting the Earth. A net may be released from the spacecraft in a manner (e.g., with a given alignment, direction and velocity) that results in the net contacting and/or entangling with the object. This contact or entanglement may alter a velocity of the space-orbital object and thereby may alter its orbital path. In some instances, the net's velocity is sufficient to cause the space-orbital object to experience increase drag by the Earth's atmosphere, relative to the drag it would have otherwise experienced if the net did not contact the object.

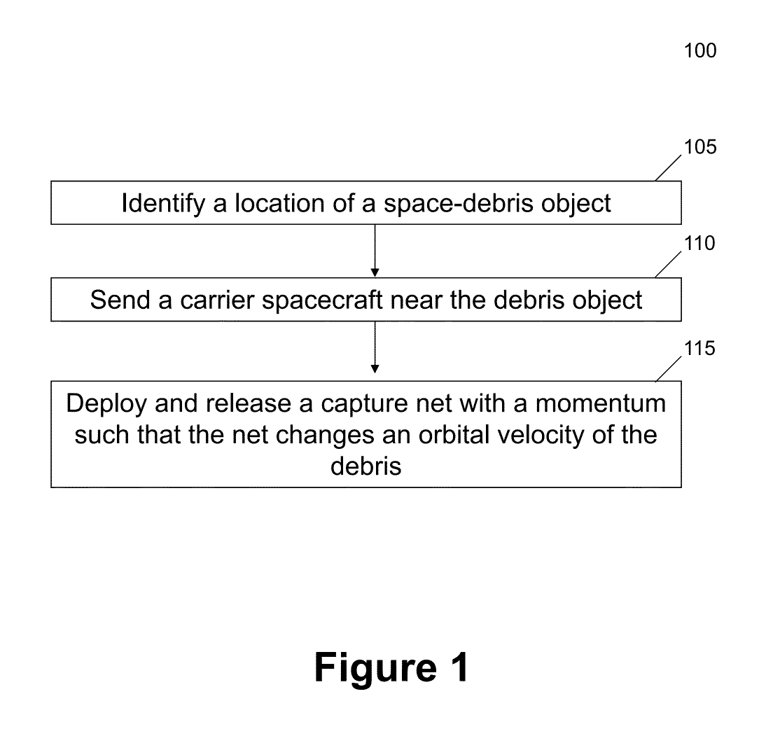

FIG. 1 shows an exemplary method 100 for altering a path of a space-orbital object. The space-orbital object may include any object in space. In some instances, the object includes an uncontrolled object in space, in that no person (via controls and/or a machine) can control the location or trajectory of the object. In some instances, the object is an object in space under limited control. For example, a person may be able to exert some control over the object's location but not precisely control the object's location. The object may include an object in space that serves no useful purpose. The object may include all or part of a satellite or launch vehicle. In some instances, the object is unidentified. In some instances, the object comprises a group of objects. Some or all of the space-orbital objects within the group of objects may have resulted from an explosion of or damage to a single device. For example, an explosion of a satellite may have resulted in a cluster of orbital objects.

At 105, a location of a space-orbital object is identified. The location may comprise a precise position, an area, a volume and/or a trajectory. For example, an object's trajectory may be estimated, and a prediction may be made as to a volume that will be occupied by the object at a particular moment in time. In some instances, the location comprises a range of locations, indicating that the object may be located in any of a plurality of locations within the range. A location may constitute a probable location. For example, a location be one in which there is a substantial probability that the object occupies or will occupy a particular volume.

A location may be identified by using a radar and/or optical detector (e.g., a telescope or a liquid mirror transit telescope). The location may be identified using a database of locations or trajectories of known orbital objects, such as a catalogue maintained by the U.S. Strategic Command. The location may be identified using information provided based on other space objects. For example, a space object may be equipped with radar or optical equipment used to detect space-orbital objects. As another example, physical deformities in a space object may indicate that a space-debris object was present in a particular location in space.

At 110, a spacecraft is controlled to approach the identified location. In some instances, a spacecraft is launched from Earth to the location, and in some instances, a spacecraft already in space is controlled such that it approaches the identified location. A spacecraft may “approach” the identified location by moving or by remaining at a fixed position while the space-orbital object moves towards it. In some instances, a desired spacecraft orbit is determined. The spacecraft orbit may include a predicted orbit of the space-orbital object or another orbit. The desired spacecraft orbit may include an elliptical orbit. The desired spacecraft orbit may be chosen such that at least one point of the desired spacecraft orbit is near at least one point of the predicted debris orbit.

A spacecraft may approach the identified location using a two-step approach. The first step may comprise a relatively high-velocity movement towards the space-orbital object. The spacecraft may move closer to the orbital object in the second step with a slower velocity. This two-step process may allow a spacecraft to quickly move to a space-orbital object, while reducing the probability that it will collide with object. The final location of the spacecraft may be near a predicted location of space-orbital object, such that it is reasonably probable that a spacecraft could propel a capture net such that it would reach the predicted location and, at that point, be travelling approximately at a desired velocity (explained in further detail below).

In some embodiments, the final location of the spacecraft is at least about, about or less than about 1, 2, 5, 10, 20, 50, 100, 500 or 1,000 feet from the orbital object. In one instance, the first step of the spacecraft-positioning positions the spacecraft at a distance of about 50-500 feet from the orbital object, and the second step positions the spacecraft at a distance of about 0.5-50 feet from the orbital object.

At 115, a capture net is deployed and released from the spacecraft. The capture net may include any device configured to engage or entangle the orbital object upon contact. For example, the net may comprise a mesh, a solid surface, or an open container. As illustrative examples, a capture net may comprise a shape similar to a fishing net, a piece of cardboard, a bowl, or an open box. In some instances, the net comprises an outer rigid perimeter. An interior surface attached to an outer perimeter may be flexible or rigid. In some embodiments, the net is completely flexible (i.e., not attached to any rigid perimeter). The capture net may be ejected using any number of techniques. For example, the capture net may be ejected using rockets, solid propellant, springs, chemical ejection, etc.

The capture net may be released with a momentum such that the net contacts the space-orbital object and alters the orbital object's orbital velocity. In some instances, the contact results in a decrease of the orbital object's orbital velocity. This may change the object's orbital path and cause the object to experience increased drag by the Earth's atmosphere. For example, the drag experienced by the object approximately half of an orbit after the contact may be less than about, about or greater than about 10%, 20%, 30%, 50%, 100% or 200% more than the drag that would have been experienced half an orbit later had the object not been contacted by net.

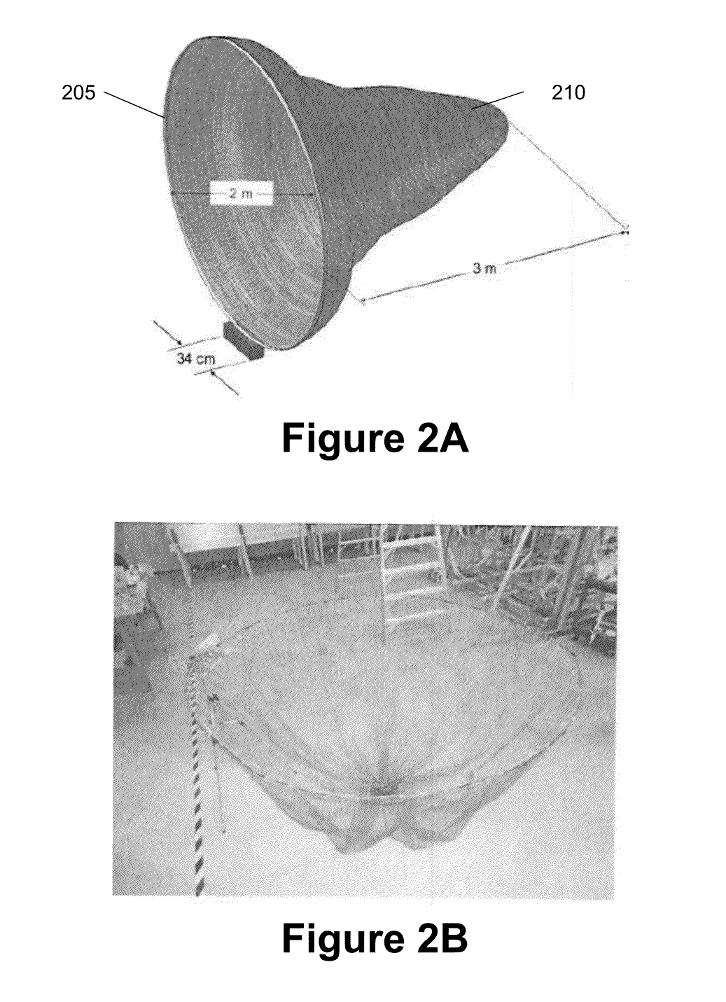

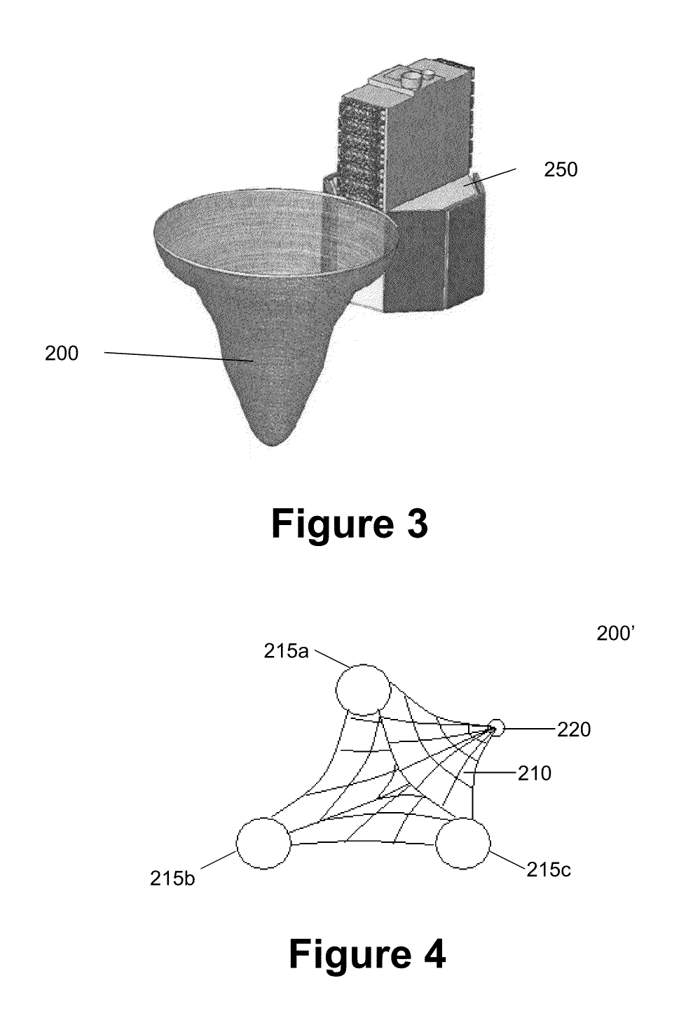

FIGS. 2-4 show examples of capture nets. In FIGS. 2 and 3 net 200 comprises a semi-rigid or rigid perimeter 205. As shown, the perimeter comprises a ring and is substantially circular. In other embodiments, the perimeter is non-circular (e.g., substantially rectangular). The perimeter may comprise a metal, such as steel or aluminum.

A netting 210 is coupled to perimeter 205. Netting 210 may comprise a solid or semi-solid (e.g., meshed) surface. Netting 210 may be rigid or flexible. For example, in some instances, all portions of net 200 shown in FIGS. 2A and 2B are substantially rigid, and a depth of net 200 (e.g., from perimeter 205 to a back of a recessed portion) is fixed. Netting 210 may comprise, for example, a plurality of rigid (e.g., metal) circles attached to each other. The diameter of these circles may vary, as shown in FIG. 2A. Netting 210 may comprise a solid surface of material, such as a sheet of plastic or metal. The solid surface may be shaped in a variety of shapes (e.g., an open box, a rectangular sheet, a dome, a cone, etc.). In some instances, the net is at least partly collapsible, such that a depth of net 200 may change.

A diameter of perimeter 205 of net 200 and/or a maximum diameter of net 200 may be at least about, about, or less than about 0.1, 0.2, 0.5, 1, 2, 5, 10, 20, 50, 100, 200, 500 or 1,000 meters. Net 200 may have a depth, defined as a distance from an open end of the net 205 to an opposite closed end of the net 205. For example, the depth of net 200 shown in FIG. 2A is labeled as being 3 m. A net may have a fixed or maximal depth of at least about, about or less than about 0.1, 0.2, 0.5, 1, 2, 5, 10, 20, 50, 100, 200, 500 or 1,000 meters.

FIG. 4 shows another embodiment of a net 200′. In this embodiment, net 200′ does not include a rigid perimeter. The net instead includes a plurality of semi-rigid or rigid anchors 215a-215c. While FIG. 4 shows an embodiment with 3 anchors, one, two, four or more anchors be used. Netting 210 may be attached to each anchor 215. FIG. 4 shows an embodiment in which a center anchor 220 is provided at an interior position (e.g., a center) of netting 210. In some instances, no interior anchor is provided.

A spacecraft may expel net 200 by propelling a rigid portion of net 200 from the spacecraft. For example, spacecraft may apply force to a rigid perimeter 205 or to rigid anchors 215 of a net. Any flexible portions of the net (e.g., a flexible netting 210) may be similarly propelled from the spacecraft due to their attachment to the rigid portions. In some instances, net 200 is coupled to one or more rockets (e.g., solid-fuel rockets). Activation of the rockets may cause the net to be propelled from a spacecraft.

In some embodiments, a net can include streamers or other device that can increase drag once the net and the orbital object enter the atmosphere. These streamers can extend a distance from the net. Multiple streamers can be used.

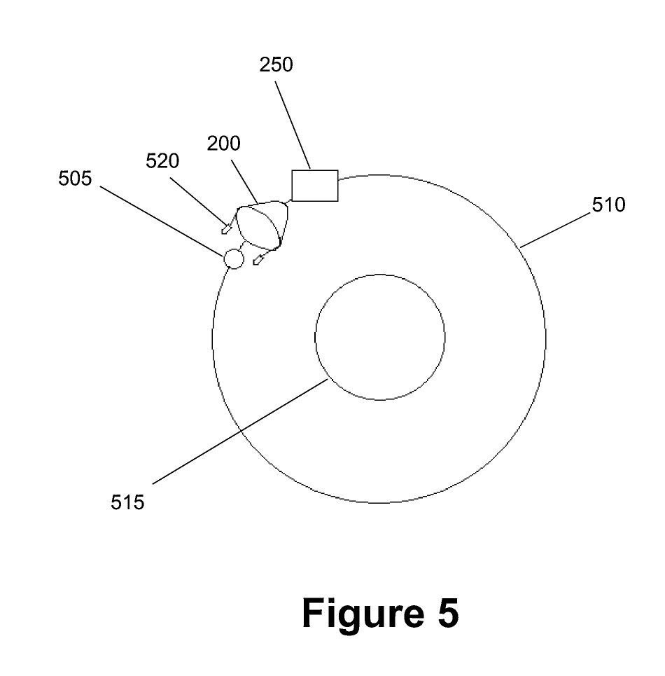

FIG. 5 shows a not-to-scale illustration of a spacecraft 250 that expelled net 200 to alter a path of space-orbital object 505. Space-orbital object 505 is depicted as orbiting along an orbital path 510 around the Earth 515. Though the orbital path is shown as being a circular path, in some instances, the orbital path is elliptical. As shown, spacecraft 250 is positioned in an orbital path of the space-orbital object. In some instances, spacecraft 250 is positioned in a different orbit, wherein at least part of the different orbit is near at least part of the space-orbital object's orbit. A desired position (and therefore a desired spacecraft orbit) of spacecraft 250 may be chosen such that the spacecraft is able to propel a net in a manner such that it is predicted that it will contact space-orbital object 505 and slow an orbital velocity of object 505. Thus, for example, spacecraft 250 may positioned such that it may propel net 200 in a manner such that it is likely that net 200 and orbital object 505 will be travelling in substantially opposite directions just prior to contact between the two.

Spacecraft 250 can include a plurality of space nets. A set of these nets can be deployed at the same time. Or a set of nets can be deployed one after another. In some situations an orbital debris may include a plurality of orbital objects. Multiple objects can be formed, for example, from a collision of two or more objects. In such situations, multiple nets may be employed to capture multiple orbital objects.

Net 200 may be positioned and propelled in a manner such that it is expected to contact and/or entangle orbital object 505. For example, a mathematical model may predict a propulsion angle that would cause net-debris contact based on the estimated location and trajectory of the orbital object, the location and trajectory of spacecraft 250, and properties of net 200 (e.g., mass, shape, etc.). Net 200 may also be positioned and propelled in a manner such that it is expected to have a velocity with at least one component opposite to a component of a velocity vector of orbital object 505. For example, net 200 may be travelling in a direction substantially opposite to orbital object's orbital path just prior to contact between net 200 and orbital object 505.

Net 200 may be released from spacecraft 250 with a force sufficient to propel net 200 to the orbital object 505 and to substantially alter (e.g., decrease) an orbital velocity of debris item 505. Therefore, a trajectory of debris item 505 may be disturbed. In some instances, the velocity is one which would be sufficient to cause debris item 505 to experience increased drag by the Earth's atmosphere (e.g., within about half an orbit). Net 200 may disturb a trajectory of debris item 505 by (1) entangling net 200 and debris item 505 and causing debris item 505 to move with net 200; or (2) altering debris item's path following a non-entangling contact between net 200 and debris item 505.

In some instances, net 200 is propelled from spacecraft 250 by using one or more (e.g., solid-fuel) rockets 520. Rockets 520 may be coupled to net 200, e.g., by solid or flexible tethers or by attachment to a portion (e.g., a ring) of net 200. Activation of one or more rockets 520 may cause the net to exit spacecraft 250. In some instances, net 200 is propelled in a direction substantially opposite to a direction in which spacecraft 250 is travelling. For example, in FIG. 5, spacecraft 250 may be travelling clockwise in an orbit, and net 200 may be propelled in a counterclockwise direction. In some instances, not all rockets 520 are activated at a same time. For example, one or more rockets may initially be activated while expelling net 200 from spacecraft 250, and one or more other rockets may be (e.g., remotely) activated later.

A desired velocity of the space net may be determined based on a mass of net 200, a predicted mass of orbital object 505, and an initial position of orbital object 505. For example, suppose that an objective is to have debris item 505 unite with net 200 and have a decreased orbital velocity. One may then calculate a desired radial velocity based on a radial distance between the orbit and the atmosphere, and an orbital speed and trajectory of object 505. Momentum is conserved, and thus, the speed of the combined net 200 and orbital object 505 will be slower than an initial speed of the net 200. An initial propulsion speed of net 200 may be chosen accordingly based on known or estimated masses of net 200 and object 505.

This velocity can also be chosen or calculated to direct the orbital object to a specific splash down or reentry point. This calculation can depend on the mass or the orbital object, the mass of the space net, the velocity of the orbital object, the orbit of the orbital object, the surface area of the orbital object, the drag provided by the space net., among other parameters.

Net 200 may be propelled from a spacecraft 250 using a variety of devices and methods. For example, a “net gun” may be used to apply force to one or more components of net 200. The net gun may comprise a component that may engage net 200. The net gun may disengage and eject net 200 from spacecraft 250 following a controlled chemical explosion, release of compressed air, deployment of a mechanical spring, or release of a component under tension. In some instances, net 200 comprises movement-generating means. For example, net 200 may include one or more rockets 520 that propel net 200 as it travels. The one or more rockets 520 may be tethered to a body of net 200 or may be part of net's 200 body (e.g., by integrating the rocket on a rigid component of net 200). An advantage of tethering the rockets is that it may reduce the probability that net 200 will be damaged following the rocket's activation.

In one embodiment, after net 200 is ejected from spacecraft 250, a rocket 520 (e.g., a small, uncontrolled rocket) coupled to net 200 (e.g., via a tether) is activated (e.g., via a remote control). Activation of the rocket 520 may be delayed until net 200 is reasonably close to orbital object 505. This dull-capture approach may allow net 200 to contact orbital object 505 with a reduced velocity and may reduce reverse momentum imparted on spacecraft 250.

While the above description has focused primarily on using a single net to alter a trajectory of a single orbital object, it will be understood that the concept can be applied more generally. For example, a plurality of nets may be used to contact one or more orbital objects. In some instances, a cluster of orbital objects is present. Each of the objects may have a slightly unique orbit that may be difficult to define. By using multiple nets, it may be possible to better account for the variety of trajectories. For example, it may be determined that the orbital objects are likely to be present within a particular region of space, and multiple nets may be propelled to target various locations within the region.

What is claimed is:

1. A method for disturbing a trajectory of a space-orbital object, the method comprising:
positioning a spacecraft near the space-orbital object, the space-orbital object comprising an uncontrolled object orbiting Earth; and
propelling a capture net from the spacecraft towards the space-orbital object.

2. The method of claim 1, wherein the capture net is propelled from the spacecraft with a velocity sufficient to cause the net to contact the orbital object, and
wherein the velocity is sufficient to cause the space-orbital object to, half an orbit after contact with the net, experience increased drag by the Earth's atmosphere as compared to the drag that would have been experienced half an orbit later had the object not been contacted by net.

3. The method of claim 1, wherein the capture net is coupled to one or more rockets.

4. The method of claim 1, wherein the capture net is propelled from the spacecraft with a velocity sufficient to substantially decrease an orbital velocity of the space-orbital object following contact between the capture net and the object.

5. The method of claim 1, wherein the spacecraft is positioned substantially along an orbit of the space-orbital object.

6. The method of claim 1, further comprising locating the space-orbital object.

7. The method of claim 1, wherein the capture net comprises a rigid perimeter and a recessed interior for receiving the space-orbital object.

8. The method of claim 1, wherein a maximal depth of the capture net is between about 1 meter and about 50 meters.

9. The method of claim 1, wherein the capture net is propelled using one or more of a chemical explosion, compressed air, and a mechanical spring.

10. The method of claim 1, wherein the capture net is shaped to at least partly contain the space-orbital object upon contact.

11. A method for identifying properties for ejecting a capture net from a spacecraft, the method comprising:
identifying a location of the spacecraft;
predicting a future location of a space-orbital object based on an estimated location and trajectory of the space-orbital object;
estimating a mass of the space-orbital object;
determining an ejection direction for ejection of the capture net based on the location of the spacecraft and the projected future location of the space-orbital object; and
determining an ejection velocity for ejection of the capture net based on a mass of the capture net, the estimated mass of the space-orbital object, and a radial distance between an orbit of the space-orbital object and the top of the Earth's atmosphere.

12. The method of claim 11, further comprising ejecting the capture net from the spacecraft at the determined ejection velocity.

13. The method of claim 11, wherein the ejection velocity is determined further based on an orbital trajectory of the space-orbital object.

14. The method of claim 11, wherein the determined ejection velocity is sufficient to cause the net to contact the space-orbital object, and
wherein the determined ejection velocity is sufficient to cause the space-orbital object to, half an orbit after contact with the net, experience increased drag by the Earth's atmosphere as compared to the drag that would have been experienced half an orbit later had the object not been contacted by net.

15. The method of claim 11, wherein determining the ejection velocity comprises:
determining a desired velocity of the space-orbital object; and
determining the ejection velocity based on a conservation-of-momentum principle.

16. A capture net for capturing a space-orbital object, the net comprising:
one or more rigid components;
a surface attached to the rigid component; and
a rocket,
wherein the capture net is formed in an open shape for receiving the space-orbital object upon propulsion of the one or more rigid components.

17. The capture net of claim 16, wherein the rigid components comprises a ring.

18. The capture net of claim 16, wherein the rigid component comprises one or more spherical anchors.

19. The capture net of claim 16, wherein a maximum diameter of the capture net is between about 0.5 meters and 20 meters.

20. The capture net of claim 16, wherein the surface is flexible.

21. The capture net of claim 16, wherein the rocket is configured to be activated by a remote control.

22. The capture net of claim 16, wherein the capture net comprises a rigid conical shape.

23. The capture net of claim 16, further comprising a tether coupling the he rocket to at least one of the one or more rigid components.
